(19) United States
(12) Patent Application Publication
(10) Pub. No.: US 2010/0315508 A1
(43) Pub. Date: Dec. 16, 2010

(54) VIDEO MONITORING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/541,174

(22) Filed: Aug. 14, 2009

(30) Foreign Application Priority Data
Jun. 12, 2009 (CN) 200910303197.5

(51) Int. Cl. H04N 7/18; G08B 13/00

(52) U.S. Cl. 348/154; 340/541; 348/E07.085

(57) ABSTRACT

A video monitoring system for monitoring an area includes a number of image capture units, a processing unit, and a storage system. The number image capture units capture a number of images. The storage system examines the number of images to find a face in the images, obtains a location where an intruder is located, estimates possible next locations according to the geographical features of the area, adjusts the corresponding cameras at the possible next locations, and notifies security guards to go to the next possible locations in advance.

### BACKGROUND

1. Technical Field

The present disclosure relates to a video monitoring system and a video monitoring method.

2. Description of Related Art

Video monitoring systems are more and more popular nowadays. However, conventional video monitoring systems just warn security guards that there are intruders entering a monitored area, and cannot predict where the intruders may go once in the area.

### BRIEF DESCRIPTION OF THE DRAWINGS

FIG. 1 is a schematic block diagram of an exemplary embodiment of a video monitoring system, the video monitoring system includes a storage system.

FIG. 2 is a schematic block diagram of the storage system of FIG. 1, the storage system includes a path storing module.

FIG. 3 is a schematic, exemplary diagram of an area.

FIG. 4 is a path table stored in the path storing module according to an embodiment.

FIGS. 5A and 5B are schematic diagrams of monitoring the area of FIG. 3 using the video monitoring system of FIG. 1.

FIG. 6 is a flowchart of an exemplary embodiment of a video monitoring method.

### DETAILED DESCRIPTION

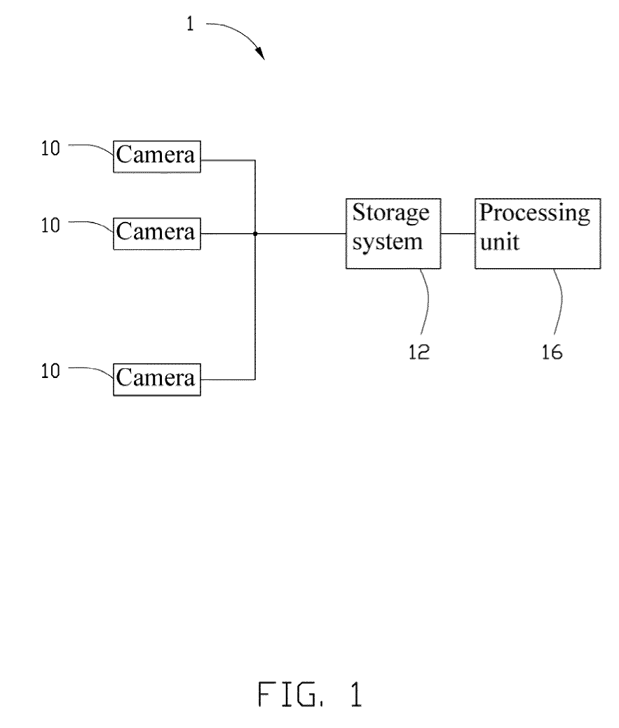

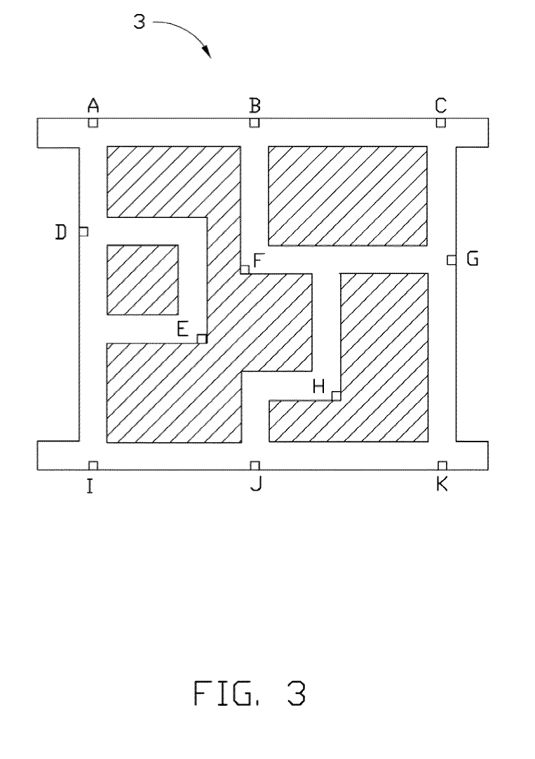

Referring to FIGS. 1 and 3, an exemplary embodiment of a video monitoring system 1 includes a plurality of image capture units, such as cameras 10, a storage system 12, and a processing unit 16. The cameras 10 are disposed in places to allow monitoring of an area 3, and coupled to the storage system 12. The storage system 12 is further coupled to the processing unit 16. The video monitoring system 1 is operable to monitor the area 3 effectively.

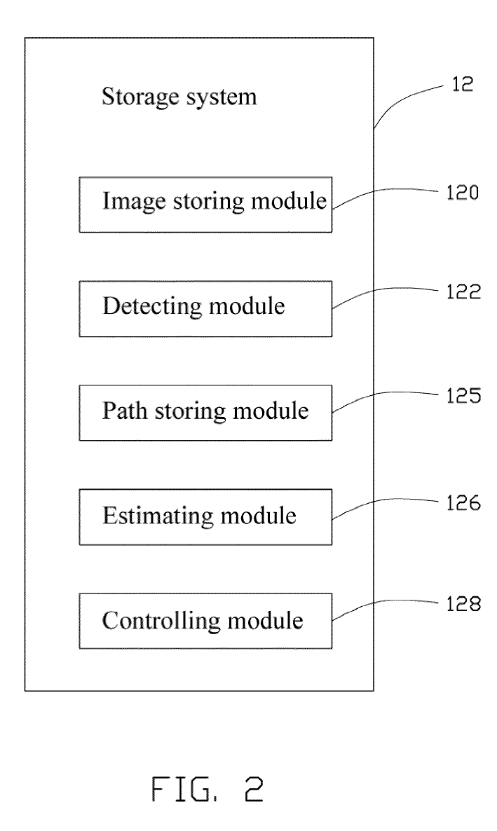

Referring to FIG. 2, the storage system 12 includes an image storing module 120, a detecting module 122, a path storing module 125, an estimating module 126, and a controlling module 128. Each of these modules may include one or more computerized instructions and are executed by the processing unit 16.

Referring again to FIG. 3, the area 3 to be monitored includes a plurality of camera locations A-K. Each camera 10 is located at one of the camera locations A-K of the area 3.

The plurality of cameras 10 capture images correspondingly.

The images are stored in the image storing module 120.

The detecting module 122 examines the images stored in the image storing module 120 to find items, such as faces, in the images to determine whether there are intruders in the area 3. It can be understood that the detecting module 122 uses a well known recognition technology to find faces in images. Upon the condition that the detecting module 122 finds a face in the images during a time of monitoring, it can be understood that there might be an intruder in the area 3. The detecting module 122 further obtains locations of the intruder.

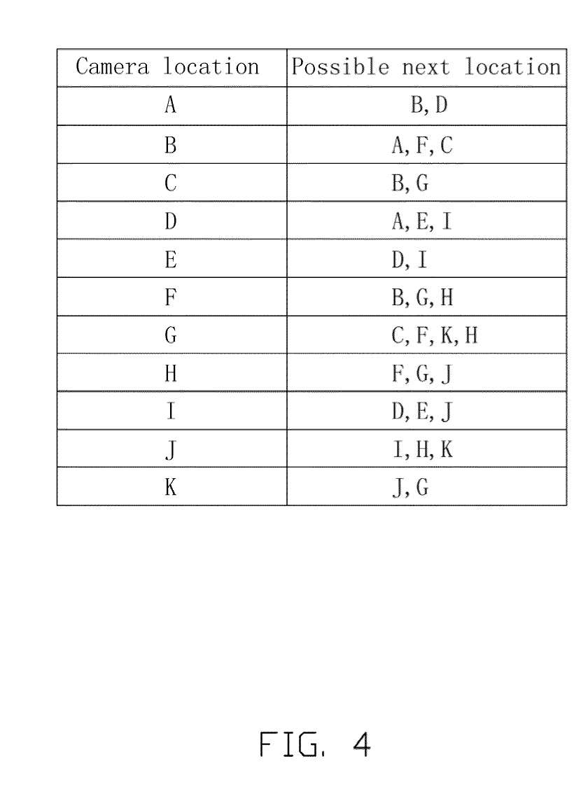

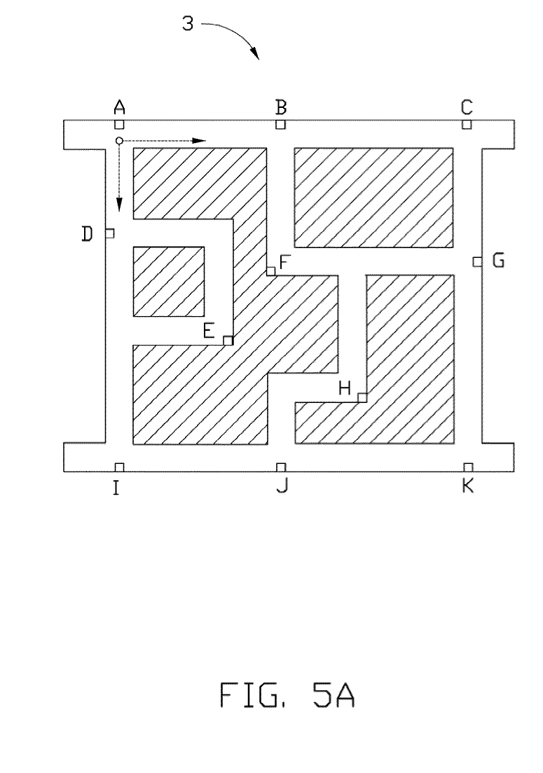

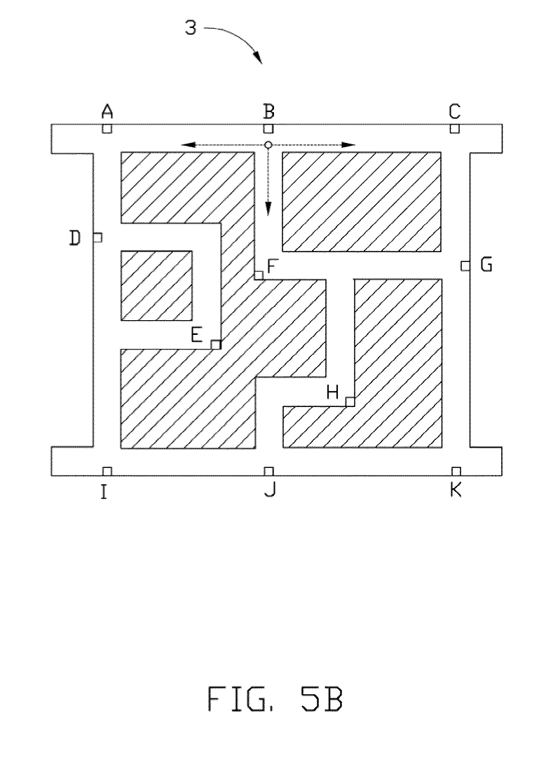

The path storing module 125 stores a path table in advance according to the geographical features of the area 3. The path table includes all locations where an intruder may be located at a given moment in the area 3 and each location has possible next locations associated with it for predicting movement of an intruder. For example, referring to FIGS. 4, 5A, and 5B, if at a given moment an intruder is located in view of camera at location A, the table indicates areas viewed by cameras at locations B and D are possible next locations for the intruder in addition to the possibility of remaining in view of the camera at location A. When the intruder is located in view of camera at location B, the table indicates areas viewed by cameras at locations A, C, and F. When the intruder is located in view of camera at location K, the table indicates areas viewed by camera at locations J and G.

The estimating module 126 receives the location where the intruder is located, and obtains possible next locations associated with it for predicting movement of the intruder according to the path table stored in the path storing module 125.

The controlling module 128 receives the possible next locations from the estimating module 126, and adjusts the corresponding cameras 10. For example, when the camera 10 determines that the intruder is located in view of camera at location A, the estimating module 126 obtains the possible next locations are locations B and D according to the path table. As a result, the controlling module 128 adjusts angles of the cameras 10 at locations B and D, and notifies security guards to go to the locations B and D in advance to intercept the intruder.

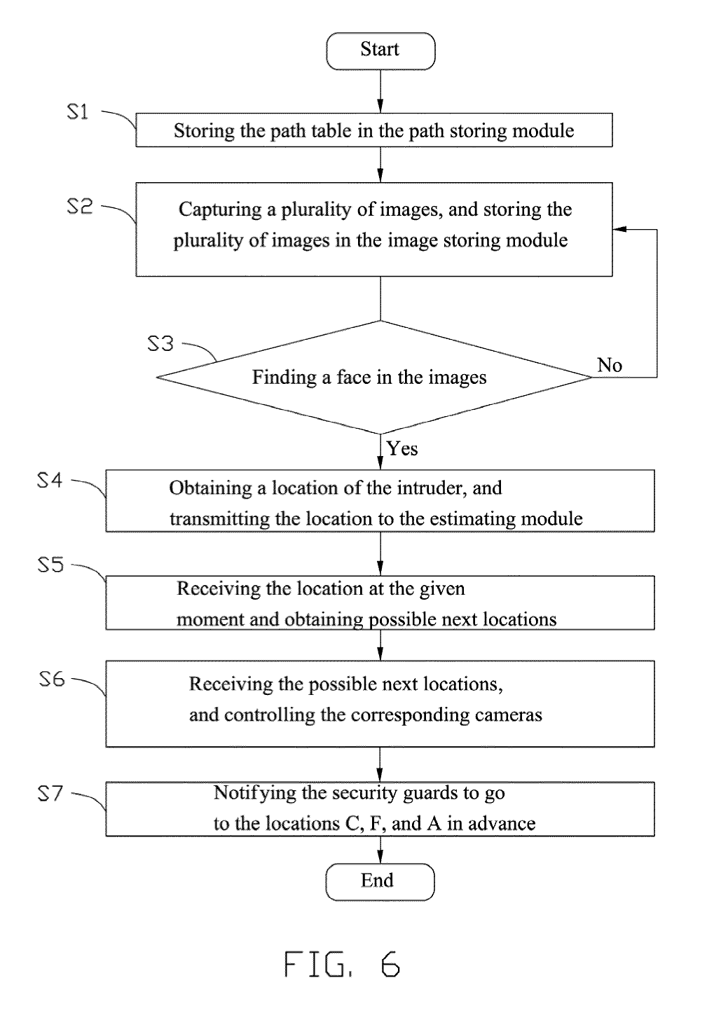

Referring to FIG. 6, an exemplary embodiment of a video monitoring method using the video monitoring system 1 in FIG. 1, for monitoring the area 3 in FIG. 3, includes the following steps.

In step S1, the path table is stored in the path storing module 125. The path table includes all locations where an intruder may be located at a given moment in the area 3 and each location has possible next locations associated with it for predicting movement of an intruder. For example, referring to FIGS. 4, 5A, and 5B, if at a given moment an intruder is located in view of camera at location A, the table indicates areas viewed by cameras at locations B and D are possible next locations for the intruder in addition to the possibility of remaining in view of the camera at location A. When the intruder is located in view of camera at location B, the table indicates areas viewed by cameras at locations A, C, and F. When the intruder is located in view of camera at location K, the table indicates areas viewed by camera at locations J and G.

In step S2, the plurality of cameras 10 capture images, and stores the images in the image storing module 120.

In step S3, the detecting module 182 examines each image to find a face in the images. Upon the condition that the detecting module 122 finds a face in the images at a given moment, it can be understood that there is an intruder in the area 3. The flow goes to step S4. Upon the condition that the detecting module 122 does not find a face in the images, it can be understood that there are no intruders in the area 3. The flow goes back to step S2. It can be understood that the detecting module 122 uses a well known recognition technology to find the faces in the images.

In step S4, the detecting module 122 obtains a location, such as the location B, of the intruder, and transmits the location of the intruder to the estimating module 126.

In step S5, the estimating module 126 receives the location of the intruder, and obtains possible next locations for predicting movement of the intruder according to the path table stored in the path storing module 125. For example, the estimating module 126 receives the location of the intruder be the location B, the estimating module 126 obtains the possible next locations are the locations C, F, and A according to the path table of FIG. 4.

In step S6, the controlling module 126 receives the possible next locations, and controls the cameras 10 according to the possible next locations correspondingly. For example, the controlling module 126 adjusts angles of the cameras 10 at the locations C, F, and A.

In step S7, the controlling module 126 further notifies the security guards to go to the locations C, F, and A in advance to intercept the intruder.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video monitoring system for monitoring an area, comprising:
a plurality of image capture units to be disposed in places of the area, to capture a plurality of images of the places;
a processing unit;
a storage system connected to the processing unit and storing a plurality of modules to be executed by the processing unit, wherein the plurality of modules comprises:
an image storing module to store the plurality of images from the plurality of image capture units;
a detecting module to examine each of the plurality of images to find a face of an intruder in the images;
a path storing module storing a path table, wherein the path table comprises all locations where an intruder may be located at a given moment in the area and each possible next location associated with each of the locations;
an estimating module to obtain possible next locations according to the location where the intruder is located at a given moment and the path table; and
a controlling module to receive the possible next locations and adjust the corresponding cameras at the possible next locations.

2. The video monitoring system of claim 1, wherein each image capture unit is a camera.

3. A video monitoring method comprising:
storing a path table in a storage system, wherein the path table comprises all locations where an intruder may be located at a given moment in the area and each location has possible next locations associated;
capturing a plurality of images, and storing the plurality of images in the storage system;
examining each of the plurality of images to find a face of an intruder in the images;
obtaining a location where the intruder being located at a given moment upon the condition that a face is found in the plurality of images;
estimating possible next locations according to the location where the intruder is located at the given moment and the path table; and
adjusting the corresponding cameras at the possible next locations.

4. The video monitoring method of claim 3, further comprising:
returning to the step of capturing the plurality images upon the condition that no face is found in the plurality of images.

5. The video monitoring method of claim 3, further comprising:
notifying security guards to go to the possible next locations in advance.

6. A video monitoring system for monitoring an area, comprising:
a plurality of image capture units to be disposed in places of the area, to capture a plurality of images of the places;
a processing unit;
a storage system connected to the processing unit and storing a plurality of modules to be executed by the processing unit, wherein the plurality of modules comprises:
an image storing module to store the plurality of images from the plurality of image capture units;
a detecting module to examine each of the plurality of images to find a face of an intruder in the images;
a path storing module storing a path table, wherein the path table comprises a first location where an intruder is located at a given moment in the area, and a plurality of second locations directly connected to the first location in the area;
an estimating module to obtain the plurality of second locations according to the first location and the path table; and
a controlling module to receive the plurality of second locations and adjust the corresponding cameras at the plurality of second locations.

7. The video monitoring system of claim 6, wherein each image capture unit is a camera.
